(19) United States
(12) Patent Application Publication
(10) Pub. No.: US 2006/0289254 A1
(43) Pub. Date: Dec. 28, 2006

(54) Drum brake apparatus

(75) Inventor: Hideki Tsukagoshi, Tokyo (JP)

Correspondence Address: MORGAN LEWIS & BOCKIUS LLP, 1111 PENNSYLVANIA AVENUE NW, WASHINGTON, DC, 20004, US

(73) Assignee: Akebono Brake Industry Co., Ltd.

(21) Appl. No.: 11/452,980

(22) Filed: Jun. 15, 2006

(30) Foreign Application Priority Data
Jun. 23, 2005 (JP) P.2005-183341

(51) Int. Cl. F16D 65/10

(52) U.S. Cl. 188/218 R

(57) ABSTRACT

In a drum brake apparatus, a mount bracket to be attached to a vehicle body includes a first flange part which protrudes from a central cylindrical part outwardly in the radial direction of a drive shaft and fixes an anchor pin thereto, and a second flange part formed by extending a part of a peripheral edge of the first flange part more outwardly in the radial direction of the drive shaft. The protruding direction of the first flange part from a center of the cylindrical part and the protruding direction of the second flange part from the center of the cylindrical part are substantially the same. An imaginary line going through the center of the cylindrical part and the anchor pin passes through a point between two of a plurality of attachment holes of the second flange part.

The present application claims foreign priority based on Japanese Patent Application No. P.2005-183341, filed on Jun. 23, 2005, the contents of which are incorporated herein by reference.

### BACKGROUND OF THE INVENTION

1. Field of the Invention

The present invention relates to a drum brake apparatus, which is suitable to be mounted on an industrial vehicle such as a fork lift. Particularly, the present invention relates to a drum brake apparatus in which strength and durability are improved without depending on increase in plate thickness.

2. Related Art

FIGS. 3 and 4 show a brake drum apparatus for front wheels of a fork lift, disclosed in JP-A-11-201203.

The drum brake apparatus 1 is provided with a drum 5 which is formed in a shape of a bottomed cylinder and integrally rotates with a front wheel 3; a pair of brake shoes 7 and 8 arranged in the drum 5, opposed to each other; a shoe driving mechanism 9 which expands the brake shoes 7 and 8 toward the inner surface of the drum 5; an anchor pin 11 which comes into contact with end portions of the brake shoes 7 and 8 in the braking time to receive a braking torque; a backing plate 13 which includes a disc portion 13a on which a side edge 7a, 8a of each brake shoe 7, 8 slides, and a cover portion 13b which extends from the periphery of the disc portion 13a in an axial direction and covers the peripheral portion of the drum 5; and a mount bracket 15 which has an attachment part for the backing plate 13 and is fixed to a vehicle body.

The mount bracket 15 includes a cylindrical part 15a into which a drive shaft of the front wheel 3 is inserted, a first flange part 15b which protrudes from one end of the cylindrical part 15a outwardly in the radial direction of the drive shaft and has a predetermined thickness, and a second flange part 15c which protrudes from a peripheral edge of the first flange part 15b more outwardly in the radial direction of the drive shaft. These parts are integrally formed by casting.

The first flange part 15b is a tightening and fixing part of the anchor pin 11, and protrudes from a center of the cylindrical part 15a upward in the vertical direction.

The second flange part 15c is a part fastened and fixed to the vehicle body, and is different from the first flange part 15b in a protruding direction. The second flange part 15c protrudes from the center of the cylindrical part 15a obliquely upward, and has, on its peripheral side, plural attachment holes 15d spaced in the circumferential direction. By screw members inserted into these attachment holes 15d, the second flange part 15c is fastened and fixed to a not-shown frame on the vehicle body side.

The shoe driving mechanism 9 shown in FIG. 3 is a wheel cylinder 9a which is arranged between opposed ends on one side of a pair of brake shoes 7, 8 and operated by oil pressure. The shoe driving mechanism 9 energizes the ends of a pair of the brake shoes in the direction where they separate from each other, thereby to expand a pair of brake shoes.

The wheel cylinder 9a is fixed to the disc portion 13a of the backing plate 13.

A pair of brake shoes 7, 8 are supported movably in relation to the disc portion 13a of the backing plate 13 by shoe hold down units 7b, 8b so that the brake shoes can perform the opening-expanding operation.

The disc portion 13a of the backing plate 13 to which a pair of brake shoes 7, 8 and the shoe driving mechanism 9 are attached, as shown in FIG. 4, is integrally fixed through a stud bolt 23 onto one end surface of the cylindrical part 15a of the mount bracket 15.

The cover part 13b of the backing plate 13 functions as a dust cover for preventing a foreign substance from intruding into the drum 5 from the outside.

The anchor pin 11 is tightened and fixed by a screw member 25 in a state where it is inserted into both of the disc portion 13a of the backing plate 13 and the first flange part 15b of the mount bracket 15.

In the above drum brake apparatus 1, the backing plate 13 is integrally fastened on the mount bracket 15 that is thick and high in strength, and the anchor pin 11 receiving the braking torque is fixed to the mount bracket 15. Therefore, compared with a conventional drum brake apparatus in which an anchor pin is fixed to only a backing plate, support rigidity of the anchor pin improves and it is possible to make the backing plate 13 thin and lightweight.

However, in the above drum brake apparatus 1, an imaginary line 27 going through a center of the cylindrical part 15a and the anchor pin 11 is apart also from the attachment hole 15d of the second flange part 15c located closest to the anchor pin 11 at a comparatively large angle θ. Therefore, when the braking torque acts on the anchor pin 11, a force in a direction where the backing plate 13 is distorted is produced by its braking torque. In result, there is a problem that deformation of torsion is easy to be produced in the backing plate 13 and the first flange part 15b.

In case that each thickness of the backing plate 13 and the first flange part 15b is increased in order to solve the problem, the weight of them increases greatly, so that original reduction of the thickness and the weight of the backing plate 13 by the integral fastening onto the mount bracket 15 are harmed.

### SUMMARY OF THE INVENTION

One or more embodiments of the present invention provide a drum brake apparatus which improves rigidity of torsion of the backing plate in relation to braking torque without increasing the thickness of a backing plate and a first flange part of a mount bracket, and can thereby improve strength and durability.

In accordance with one or more embodiments of the present invention, a drum brake apparatus is provided with: a mount bracket, wherein the drum brake apparatus is mounted to a vehicle body through the mount bracket. The mount bracket is provided with: a cylindrical part, wherein a drive shaft is inserted into the cylindrical part; a first flange part protruding from the cylindrical part outwardly in a radial direction of the drive shaft, wherein an anchor pin is fixed to the first flange part; a second flange part protruding from a peripheral edge of the first flange part more outwardly in the radial direction; and a plurality of attachment portions formed on the second flange part, wherein the mount bracket is fixed to the vehicle body using the attachment portions. An imaginary line going through a center of the cylindrical part and the anchor pin passes between two of the attachment portions.

Further, the plurality of attachment portions may comprise a plurality of attachment holes.

Moreover, the cylindrical part, the first flange part, and the second flange part may be integrally formed so that the mount bracket is a single piece.

In addition, the drum brake apparatus may further be provided with: a backing plate, wherein a brake shoe is slidable on the backing plate. The anchor pin may penetrate through the first flange part and the backing plate.

Further, the first flange part may overlaps with the backing plate.

In accordance with one or more embodiments of the present invention, the imaginary line going through the center of the cylindrical part of the mount bracket and the anchor pin is set so as to passes through a point between the plurality of attachment holes for fixing to the vehicle body which are provided on the second flange part of the mount bracket. Therefore, since the first flange part to which the anchor pin is fixed and the second flange part fixed to the vehicle body are protruding substantially in the same direction in the radial direction, the braking torque acts as shearing force of the plural fastening members by which the second flange part is fixed to the vehicle body, and the braking torque is transmitted efficiently to the vehicle body side through the plural fastening members by which the second flange part is fixed to the vehicle body.

Namely, even when the braking torque acts, the force in the direction where the backing plate is distorted becomes difficult to be produced, so that the deformation of torsion becomes difficult to be produced in the backing plate and the first flange part of the mount bracket.

Such the constitution in which the first flange part to which the anchor pin is fixed and the second flange part fixed to the vehicle body are nearly the same in the protruding direction in the radial direction is realized by moving the equipment position of the anchor pin in the circumferential direction. Therefore, without increasing the respective thickness of the backing plate and the first flange part of the mount bracket, it is possible to improves rigidity of torsion of the backing plate in relation to the braking torque, and improve strength and durability of the drum brake apparatus.

Other aspects and advantages of the invention will be apparent from the following description and the appended claims.

### BRIEF DESCRIPTION OF THE DRAWINGS

FIG. 1 a front view of a drum brake apparatus according to one exemplary embodiment of the invention.

FIG. 2 is a sectional view taken along a line B-B of the drum brake apparatus shown in FIG. 1.

FIG. 3 is a front view of a conventional drum brake apparatus.

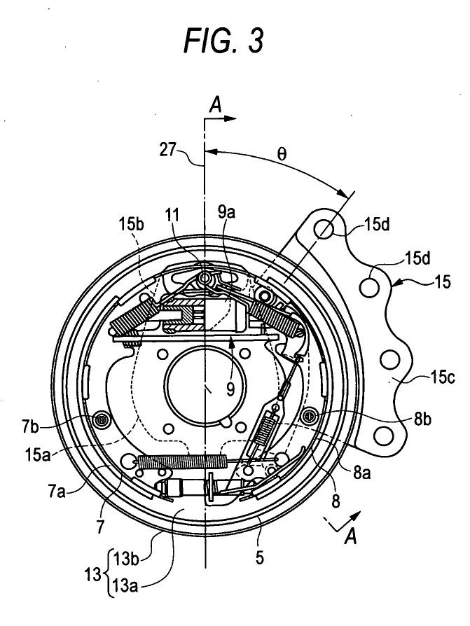

FIG. 4 is a sectional view taken along a line A-A of FIG. 3

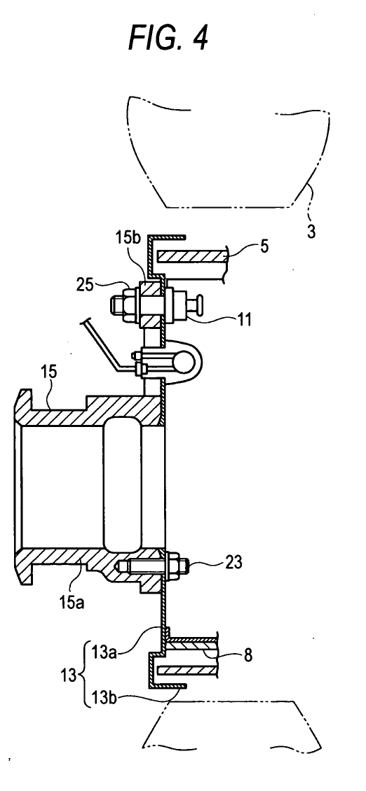

### DETAILED DESCRIPTION OF THE EXEMPLARY EMBODIMENTS

Exemplary embodiments of the invention will be described with reference to the accompanying drawings.

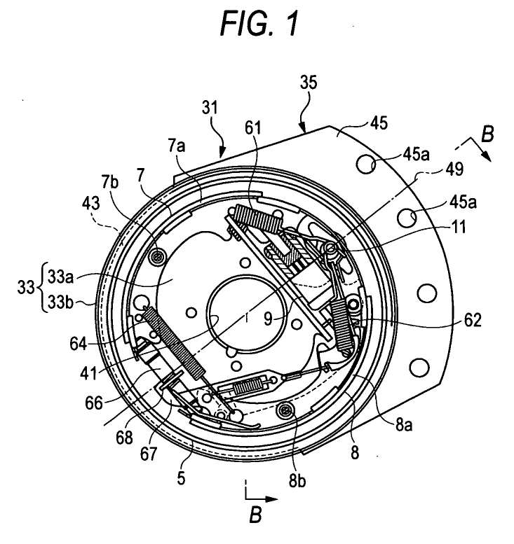

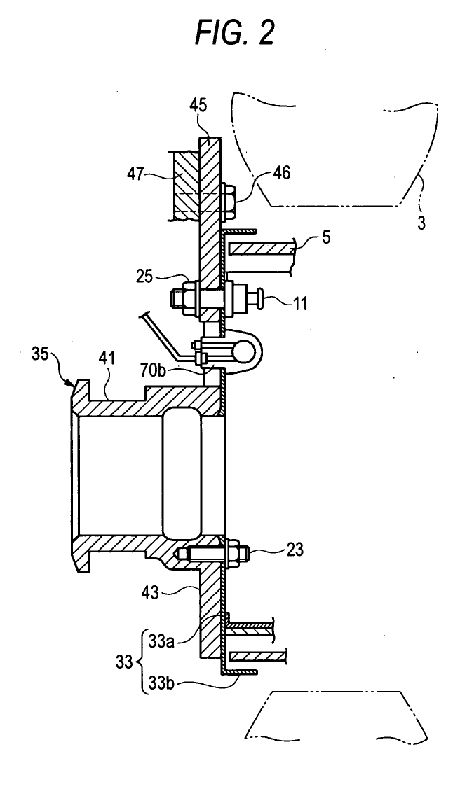

FIGS. 1 and 2 show a drum brake apparatus according to an exemplary embodiment of the present invention, in which FIG. 1 is a front view of the drum brake apparatus, and FIG. 2 is a sectional view taken along a line B-B of the drum brake apparatus shown in FIG. 1.

The drum brake apparatus 31 according to the exemplary embodiment is a duo-servo type drum brake apparatus for braking front wheels of a fork lift. The drum brake apparatus 31 includes a drum 5 which is formed in the shape of a bottomed cylinder and rotates integrally with a front wheel 3; a pair of brake shoes 7 and 8 arranged in the drum 5, opposed to each other; a shoe driving mechanism 9 which expands these brake shoes 7 and 8 toward the inner surface of the drum 5; an anchor pin 11 which comes into contact with end portions of the brake shoes 7 and 8 in the braking time to receive a braking torque; a backing plate 33 which includes a disc portion 33a in relation to which a side edge 7a, 8a of each brake shoe 7, 8 slides and a cover portion 33b which extends from the periphery of the disc portion 33a in an axial direction and covers the peripheral portion of the drum 5; and a mount bracket 35 which has an attachment part for the backing plate 33 and is fixed to a vehicle body.

The mount bracket 35 includes integrally a cylindrical part 41 into which a not-shown drive shaft of the front wheel 3 is inserted, a first flange part 43 which protrudes nearly in the shape of a circle from one end of the cylindrical part 41 outwardly in the radial direction of the drive shaft and is superimposed on the disc portion 33a of the backing plate 33, and a second flange part 45 formed in the shape in which a part of the peripheral edge of the first flange part 43 is extended more outwardly in the radial direction of the not-shown drive shaft. The cylindrical part 41, the first flange part 43, and the second flange part 45 are integrally formed so that the mount bracket is a single piece. An anchor pin 11 is fixed into the first flange part 43. Further, the second flange part 45, which is apart fastened and fixed to the vehicle body, is equipped so as to protrude from a center of the cylindrical part 41 obliquely upward, and has on its peripheral side plural attachment holes 45a (as attachment portions 45a) spaced in the circumferential direction. As shown in FIG. 2, by screw members 46 inserted into these attachment holes 45a, the second flange part 45 is fastened and fixed to a frame 47 on the vehicle body side.

In case of the exemplary embodiment, as the attachment position of the anchor pin 11 on the first flange part 43, according to the protruding direction of the second flange part 45, an obliquely upward position of a center of the cylindrical part 41 is selected. Hereby, the protruding direction of the first flange part 43 supporting the anchor pin 11 from the center of the cylindrical part 41 and the protruding direction of the second flange part 45 fixed to the vehicle body frame 47 from the center of the cylindrical part 41 are matched nearly.

Further, as shown in FIG. 1, an imaginary line 49 going through the center of the cylindrical part 41 and the anchor pin 11 is set so as to run between the plural attachment holes 45a for fixing to the vehicle body provided on the second flange part 45 of the mount bracket 35.

The disc portion 33a of the backing plate 33 is integrally fixed through a studbolt 23 onto one end surface of the cylindrical part 41 of the mount bracket 35.

Further, the anchor pin 11 is tightened and fixed by a screw member 25 in a state where the anchor pin 11 penetrates through both of the disc portion 33a of the backing plate 33 and the first flange part 43 of the mount bracket 35.

The structure in which a pair of brake shoes 7, 8 are supported movably in relation to the disc portion 33a of the backing plate 33 by shoe hold down units 7b, 8b so that the brake shoes 7, 8 can perform the opening-expanding operation, and the constitution of the shoe driving mechanism 9 which expands a pair of brake shoes 7 and 8 toward the inner surface of the drum 5 may be similar to those in the conventional case, which is complementary description of general structure of the duo-servo type drum brake apparatus. Further, regarding a pair of brake shoes 7 and 8 opposed to each other, one end of the brake shoe 7 and one end of the brake shoe 8 which are opposed to each other are energized by anchor toe shoe springs 61 and 62 in a direction where their ends come close to each other, and the other opposed ends of a pair of brake shoes 7 and 8 are energized by a shoe toe shoe spring 64 in a state where they come into contact with an adjuster unit 66.

By rotational movement of an adjuster lever 67 which cooperates with the opening-expanding operation of the brake shoes 7, 8, an adjust gear 68 is rotation-driven, whereby the adjuster unit 66 expands and keeps a clearance between each brake shoe 7, 8 and the drum 5 constant.

In case of the above drum brake apparatus 31, the imaginary line 49 going through the center of the cylindrical part 41 of the mount bracket 35 and the anchor pin 11 is set so as to run between the plural attachment holes 45a for fixing to the vehicle body provided on the second flange part 45. Since the diametrally protruding direction of the first flange part 43 to which the anchor pin 11 is fixed and the diametrally protruding direction of the second flange part 45 fixed to the vehicle body are matched nearly, the braking torque acts as shearing force of the plural screw members 46 by which the second flange part 45 is fixed to the vehicle body, and the braking torque is transmitted efficiently to the vehicle body frame 47 through the plural screw members 46 by which the second flange part 45 is fixed to the vehicle body.

Namely, even when the braking torque acts, the force in the direction where the backing plate 33 is distorted becomes difficult to be produced, so that the deformation of torsion becomes difficult to be produced in the backing plate 33 and the first flange part 43 of the mount bracket 35.

Such the constitution in which the first flange part 43 to which the anchor pin 11 is fixed and the second flange part 45 fixed to the vehicle body are similarly the same in the protruding direction in the radial direction is realized by moving the equipment position of the anchor pin 11 in the circumferential direction by the predetermined angle (for example, 45°). Therefore, without increasing the respective thickness of the backing plate 33 and the first flange part 43 of the mount bracket 35, it is possible to improves rigidity of torsion of the backing plate 33 in relation to the braking torque, and improve strength and durability of the drum brake apparatus.

It will be apparent to those skilled in the art that various modifications and variations can be made to the described preferred embodiments of the present invention without departing from the spirit or scope of the invention. Thus, it is intended that the present invention cover all modifications and variations of this invention consistent with the scope of the appended claims and their equivalents.

What is claimed is:

1. A drum brake apparatus comprising:
amount bracket, wherein the drumbrake apparatus is mounted to a vehicle body through the mount bracket, the mount bracket including:
a cylindrical part, wherein a drive shaft is inserted into the cylindrical part;
a first flange part protruding from the cylindrical part outwardly in a radial direction of the drive shaft, wherein an anchor pin is fixed to the first flange part;
a second flange part protruding from a peripheral edge of the first flange part more outwardly in the radial direction; and
a plurality of attachment portions formed on the second flange part, wherein the mount bracket is fixed to the vehicle body using the attachment portions,
wherein an imaginary line going through a center of the cylindrical part and the anchor pin passes between two of the attachment portions.

2. The drum brake apparatus according to claim 1, wherein the plurality of attachment portions comprise a plurality of attachment holes.

3. The drum brake apparatus according to claim 1, wherein the cylindrical part, the first flange part, and the second flange part are integrally formed so that the mount bracket is a single piece.

4. The drum brake apparatus according to claim 1, further comprising:
a backing plate, wherein a brake shoe is slidable on the backing plate,
wherein the anchor pin penetrates through the first flange part and the backing plate.

5. The drum brake apparatus according to claim 4, wherein the first flange part overlaps with the backing plate.
